(19) United States
(12) Patent Application Publication
(10) Pub. No.: US 2004/0155795 A1
(43) Pub. Date: Aug. 12, 2004

(54) Systems and methods for motor vehicle-based emergency/hazard detection

(76) Inventor: Nina Mariah C. Quintana, Santa Fe, NM (US)

Correspondence Address: Luis M. Ortiz, Ortiz & Lopez, PLLC, P.O. Box 4484, Albuquerque, NM, 87196, US

(21) Appl. No.: 10/748,926

(22) Filed: Dec. 30, 2003

Related U.S. Application Data
(60) Provisional application No. 60/437,131, filed on Dec. 30, 2002.

(51) Int. Cl. G08G 1/00

(52) U.S. Cl. 340/902

(57) ABSTRACT

An emergency vehicle detector (EVD) operating as a safety device in association with any motor vehicle enables motorists to be warned of emergencies/hazards existing near the motor vehicle or within its path of travel. In more developed state an emergency/hazard detection system can include a signal generator that can be placed within an emergency vehicle or stationary object related with a potential hazard to transmit a warning in the form of at least one of optical, radio frequency, radar or infrared signatures to EVDs associated with civilian motor vehicles. The EVD includes an emergency signal detector adapted to detect emergency signal emitted by emergency transmitters; a direction module for determining the general location of the emergency signal's emission with respect to the motor vehicle; an alarm generator for generating a visual alarm; a display for indicating the direction of an emergency with respect to the motor vehicle. An emergency/hazard detection system can including EVDs associated with motor vehicles can also be adapted to also detect from what location (e.g., left, right, rear, front) relative to an operator's motor vehicle and emergency, emergency vehicle, or other situation requiring caution (e.g., school bus stops, pedestrian crossing/crosswalks, school zones, road construction) is located. Vehicle signatures that the EVD can be designed to detect include ambulance, police and fire engine light patterns, and conditions associated with school buses, heavy pedestrian activity within crosswalks and school zones.

### STATEMENT OF APPLICATION PRIORITY

This patent application claims priority to a Provisional Application Serial No. 60/437,131, which was filed Dec. 30, 2002, and was entitled “SYSTEMS AND METHODS FOR MOTOR VEHICLE-BASED EMERGENCY/HAZARD DETECTION.”

### FIELD OF THE INVENTION

The invention is generally related to emergency notification systems and methods. More particularly, the present invention is related to methods and system for identifying the presence and general location of an emergency

### BACKGROUND

Today's well-insulated vehicles can prevent operators from hearing emergency vehicles. Modern motor vehicles have been advanced to the point that a substantial amount of vibration and exterior noise have been all but eliminated from their interior. With such advances, how are operators of such vehicles ever to hear an approaching ambulance, fire engine or police vehicle in the event of an emergency? Would an operator be able to hear an emergency vehicle in time so as to not endanger his/her life, or that of the person being transported in an ambulance? Furthermore, operating a vehicle with its windows rolled down will never be an acceptable solution to the present problem.

The prior art has attempted to solve the problem of providing advanced emergency warning to motor vehicles operators. To date, however, it is not clear whether systems for providing advanced warning have been successfully implemented; thus, there does not seem to be an existing solution for this important problem. Patents that have been reviewed and appear to describe attempts at solving the problem are: U.S. Pat. Nos. 3,873,963; 3,412,378; 4,158,190; 4,587,522; 4,380,004; 4,209,769; 3,859,623; 3,568,144; 4,706,086; 4,759,069; 4,785,474; 4,794,394; 5,126,735; 5,235,329; 5,278,553; 5,287,411; 5,289,181; 5,307,060; 5,495,242, 5,495,243; 5,559,508, 5,572,201; 5,629,689; 5,739,767; 5,757,284; 5,805,103, 5,808,560, 6,011,492, 6,449,540, 6,476,726, and 6,484,091. These patents are hereby incorporated by reference herein for their teachings.

The present inventor believes that improved systems and methods are needed for providing advanced emergency warnings and information of potentially hazardous situations to motor vehicle operators. The present inventor provides herein methods and systems they believe provide improved advanced warning of emergencies and potential hazards to motor vehicle operators.

An emergency vehicle detector (EVD) is also disclosed that can overcome current technological advancements in motor vehicle insulation (or sound-proofing) from exterior noise and wind turbulence. The EVD emits a series of lights and/or sounds and can do so in a pattern that can allow drivers ample time to become aware of her/his surroundings and safely react (e.g., by moving to the far right lane and halting if necessary).

### SUMMARY OF THE INVENTION

An Emergency Vehicle Detector (EVD) system in accordance with the present invention works as a safety device in association with any automobile that can allow its motorists (motor vehicle operator) to become conscious (warned) of potential hazards that may exist within the motorist's path of travel due to the presence of potential obstacles, such as emergency vehicles.

The EVD in its simplest form wirelessly detects high pitch sounds associated with emergency vehicle sirens on ambulances, fire engines and police vehicles. In more developed state the EVD can include a signal generator that is placed within an emergency vehicle to transmit either radar or infrared signatures into passenger/civilian vehicles allowing the vehicles to communicate.

With the assistance of the present invention motorists can actively interpolate hazards rendered by a warning communicator (e.g., displayed or audible) and react accordingly. For example, the EVD system can warn drivers through series of flashing lights that an emergency is in progress and there is a need for extra cautious driving during the time it flashes. A series of lights in a specific pattern is emitted from the EVD system's display allowing the driver ample time to slow, become aware of surroundings, move to the far right lane and halt if necessary. Alternatively, the EVD can warn drivers through a series of audible warnings, such as digitized voice commands, emitting from a speaker (e.g., vehicle stereo system) about an existing condition requiring extra caution.

In accordance with a method of the present invention, a vehicle-based emergency detection unit is provided in a motor vehicle for detecting the existence of an hazard or emergency near the motor vehicle housing the emergency detection unit. An emergency signal transmitted by an emergency signal transmitter is received using the emergency detection unit. The unit determines the location of an emergency using the emergency detection unit, wherein the location is based on the signal transmitted by the emergency signal transmitter and received by the emergency detection unit. The unit provides an alarm. The alarm can include at least one of an audio and visual indication to occupants of the motor vehicle. The alarm indicates the existence and general location of the emergency based on said step of determining the location of an emergency carried out by the emergency detection unit.

In accordance with a system of the present invention, an emergency vehicle detector (EVD) system includes: an emergency signal detector adapted to detect emergency signal emitted by emergency transmitters; a direction module for determining the general location of the emergency signal's emission with respect to the motor vehicle; and alarm generator for generating at least one of an audible and visual alarm for motor vehicles operators.

Vehicle signatures that the EVD can be designed to detect include ambulance, police and fire engine light patterns, and conditions associated with school buses, heavy pedestrian activity within crosswalks and school zones. The EVD can also be adapted to detect from what location (e.g., left, right, rear, front) relative to an operator's motor vehicle and emergency, emergency vehicle, or other situation requiring caution (e.g., school bus stops, pedestrian crossing/crosswalks, school zones, road construction) is located.

### BRIEF DESCRIPTION OF THE DRAWINGS

FIG. 1 illustrates a system block diagram in accordance with embodiments of the present invention.

FIG. 2 illustrates a display in accordance with one aspect of the present invention.

FIG. 3 illustrates a flow diagram in accordance with a method of the present invention.

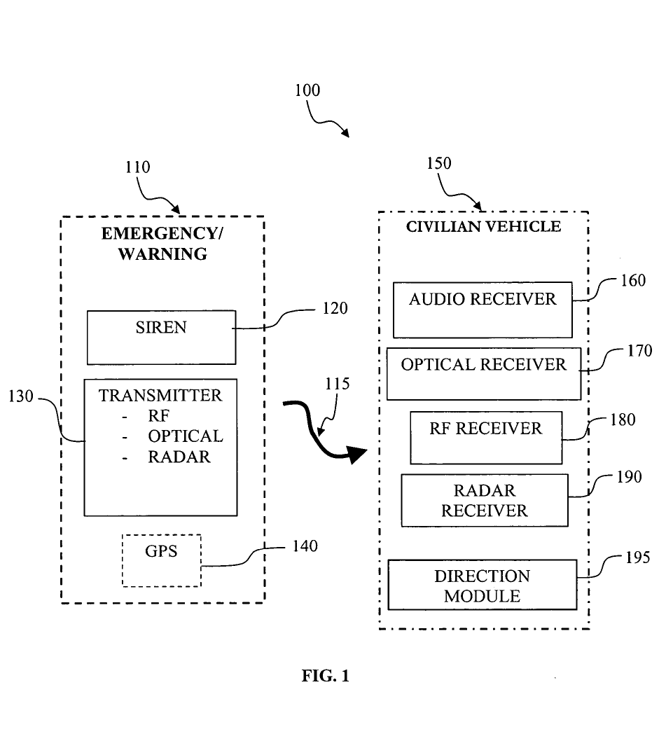

FIG. 1 illustrates a flow diagram in accordance with another method of the present invention.

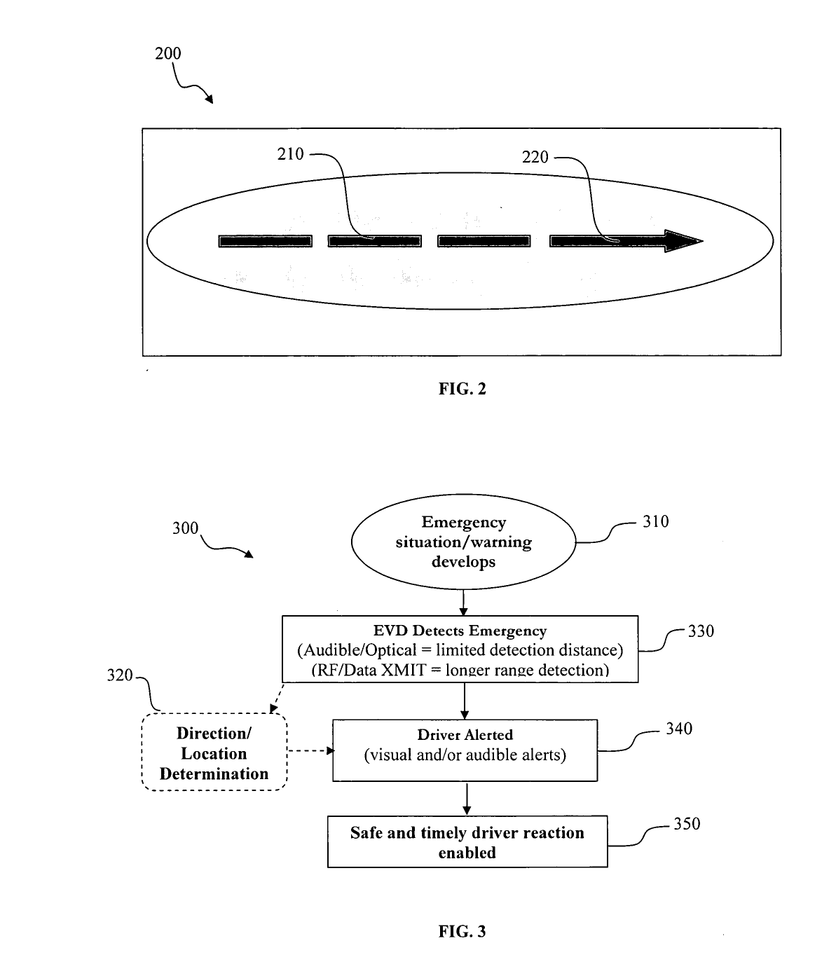

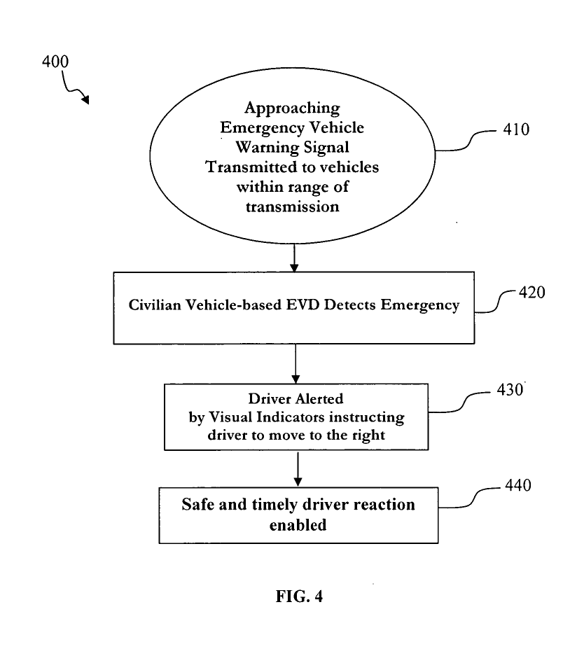

FIG. 2 illustrates a flow diagram in accordance with another method of the present invention.

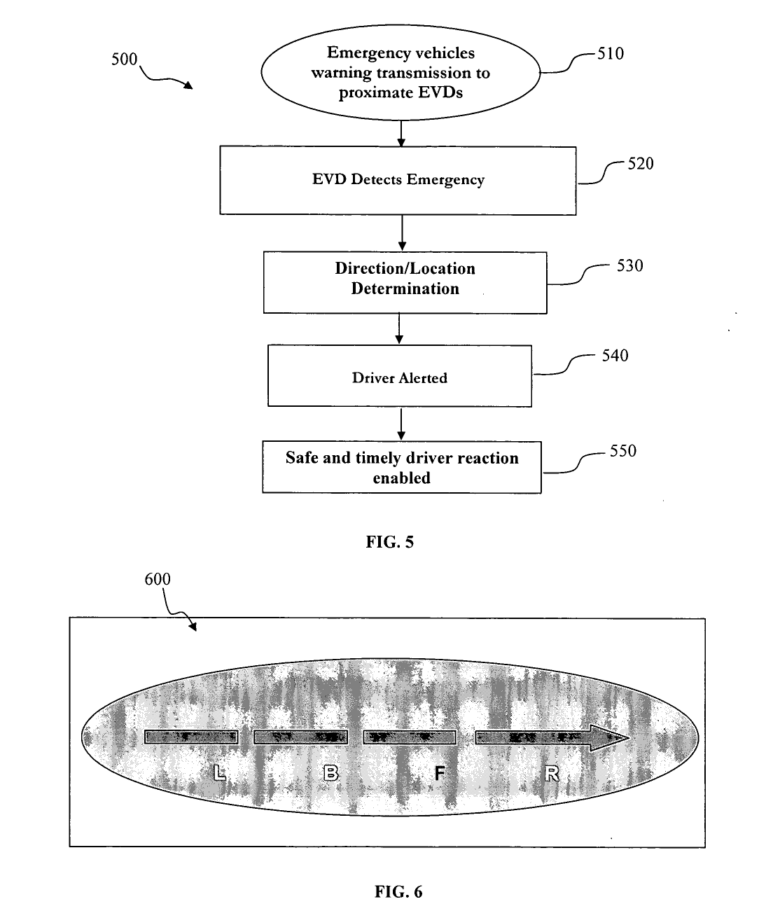

FIG. 3 illustrates a display in accordance with another aspect of the present invention.

### DETAILED DESCRIPTION OF THE INVENTION

An Emergency Vehicle Detection (hereinafter “EVD”) can wirelessly detect potentially harmful situations along a roadway. For example signals emitted from an emergency vehicle (e.g., vehicle signatures) can be in the form of radio frequency (RF), audible sirens and light pattern signals transmitted from an EVD transmitter can be detected by EVDs. The detected signal can cause the EVD to generate its own patterns of lights and/or alarms using a signal generator, the patterns being associated with the type of signal received from a transmitter. Various equipment and standards are known in the art for providing radio frequency data communications; however, according to some features of present invention unique methods of using transmitted data are provided.

Referring to FIG. 1, a block diagram of an emergency vehicle detection system, 100 including emergency signal generator 110 and EVDs 150 can be deployed. The emergency or warning can be wirelessly conveyed 115 (as shown by the arrow) from emergency signal generator 110 associated with servicing a potential roadway hazard to more than one civilian motor vehicle having EVD 150 capabilities. The emergency warning can be provided in the form of a standard audible siren 120, commonly used by emergency vehicles and well known in the art, or via a transmitter 130 installed in association with the potential hazard (e.g. vehicle or stationary warning unit). The transmitter can be associated with an emergency vehicle or a stationary object, such as a light pole, near a pedestrian area.

EVDs 150 can be installed within civilian vehicles as aftermarket products or during manufacturing. EVDs 150 can receive emergency/warning information in the form of vehicle signatures via an audio receiver 160, optical receiver 170 or radio frequency signal receiver 180. The audio receiver 160 can be responsive to an emergency vehicle's siren. The optical receiver 170 can be responsive to data provided by emergency/warning transmitters optically (e.g., IR, laser signal). The radio frequency signal receiver 180 can be responsive to warning signals transmitted from emergency equipment associated with mobile or fixed equipment. A radar receiver 190 can be responsive to radar signals emitted from a radar transmitter.

An EVD transmission system can include a signal generator that is placed within an emergency vehicle to transmit at least one of radar, radio frequency, and infrared/optical signature into nearby vehicles, allowing vehicles equipped with EVD capability to receive the transmission. Transmission and receipt hardware allows for emergency and civilian vehicles to communicate status/hazard information. Emergency vehicle signatures/station signatures can be produced by signal generators (audio, light, radar) and received by proximate EVD detectors, whereinafter the signals are used by the EVDs to warn vehicle operators. Signal generation by transmitters (single generators) and EVDs (receivers) enable emergency transmitters (stationary or vehicle-based) to communicate. Emergency vehicle or hazard location data can be processed by the EVD described herein using a directional module 195, e.g. based on location signals provided by a location module 140 at the transmitter, e.g., including GPS, signal triangulation or other techniques that may be known in the art for establishing the incoming direction of a target of interest. EVP-based sensors would be reactive to optical or radar waveform stimulus whereas GPS devices rely on the transfer of location data.

According to another feature of the present invention, a unique series and/or pattern of lights and/or sounds associated with potential hazards can range from indications of the activation of vehicle turn signal, crosswalk signals, and equipment associated to that of school buses operating at intended drops and stops. Referring to FIG. 2, an example indicator interface 200 is shown. The indicator interface 200 can include a red line of lights 210 that can blink in series from left to right with an arrow 220 that can be used to advise a driver to move to the far right lane so that the emergency vehicle can pass safely without endangering anyone.

Referring to FIG. 3, a flow chart 300 illustrates how an EVD system in accordance with a first embodiment of the present invention can be used. During normal operation, the EVD associated with a civilian vehicle should sense a signal (e.g., receive audible or radar-related signal wirelessly) emitted from an approaching emergency vehicle as shown in Step 310. As shown in optional Step 320, transmitter location and direction information can be determined from the signal being received. As shown in Step 330 the driver of the civilian vehicle is alerted of the emergency by the EVD. The alert and be at least one of audio and visual alarm indicators. For example, a series of indicator lights illuminate in a display associated with the EVD, the indicator light illuminated forming a specific pattern associated with the type of signal sense. As shown in Step 330, a driver of the civilian vehicle sees and/or hears the signal and is provided with ample time to take evasive action (e.g., to slow, become aware of visual surroundings and respond accordingly).

Referring to FIG. 4, a flow diagram 400 in accordance with another method of the present invention is illustrated. As shown in Step 410, an approaching emergency vehicle (e.g., ambulance, police or sheriff's vehicle) traveling within transmission range of the (e.g., about 2000 feet) from EVDs emits an emergency signal. The signal can be a combination of audio and visual indicators. As shown in Step 420, the emergency signal causes proximate EVD systems to illuminate a red line of lights in series from left to right. An illuminated arrow denotes the need for the driver to move to the far right lane as emergency vehicle approaches (as shown in the following figure) as shown in Step 430. The lights and arrow can quicken its blinking as the emergency vehicle closes in on driver's vehicle. As shown in Step 440, a driver of the civilian vehicle sees and/or hears the signal and is provided with ample time to take evasive action (e.g., to slow, become aware of visual surroundings and respond accordingly).

As described with regard to the system, in accordance with another embodiment of the present invention, an EVD can indicate from which direction an emergency vehicle may be approaching or in which direction the potential hazard exists. Referring to FIG. 5, a flow diagram 500 in accordance with another method of the present invention is illustrated. As shown in Step 510, an approaching emergency vehicle (e.g., ambulance, police or sheriff's vehicle) emits an emergency signal, which can be one or a combination of audible, visual, radio frequency and radar signals and can be received by at least one EVD located within the proximity of the emergency vehicle (e.g., a range of about 2000 feet). As shown in Step 520, the received emergency signal causes an EVD transmitter to transmit/emit a warning, which can be in the form of lights. As shown in Step 530, the emergency vehicles location with respect to EVD locations is determined. As shown in Step 540, a direction indicator on the EVD monitor indicates to the driver of the vehicle the general direction that an incoming emergency signal (e.g., vehicle) is coming from, such as: “L” for left; “B” from behind; “F” frontal; “R” from the right. As shown in Step 550, the driver should be given ample time to take evasive action once the warning is received, processed and delivered to the driver.

Referring to FIG. 6, an example of a direction indicator 600 operable with the present invention is illustrated. As shown in FIG. 6, the L on the EVD monitor indicates the incoming emergency vehicle is coming from the left; B from behind the driver's vehicle; F means in front of driver's vehicle; R means the right of the driver's vehicle. It should be appreciated that more than two lights can illuminate at once, thereby indicating location as being between the two illuminated locations (e.g., “L and B” is the right rear of the driver's car).

In accordance with an example usage of EVDs, prior to a school bus releasing its STOP sign, blinking lights atop the school bus are implicitly used to warn drivers. In accordance with yet another embodiment of the present invention an EVD can be adapted to: read a unique signature from a transmitter. School bus vehicle signature; The EVD can be adapted to detect unique signatures from ambulances, police cars, fire engines, school buses and stationary targets (e.g., crosswalks or school zones); and emit a red line of lights simultaneously without the arrow denoting a need for driver to halt, as shown in the following figure.

There are several reasons the EVD is unique in today's public, including:

Car windows do not need to be rolled down to determine whether or not an emergency vehicle is around.

Regardless of car windows being tinted too dark, the EVD assists the driver by acting as additional “eyes” to warn the driver of an impending emergency.

With today's well insulated vehicles, radio volume, cell phone calls, and screaming children do not deter the EVD from doing what it is intended to do and that is to keep everyone on the road safe and aware of impending emergencies and surroundings.

The more developed state of the EVD is to incorporate crosswalk signals so that visually or hearing-impaired pedestrians are kept safe while crossing a seemingly safe crosswalk.

School buses can safely come to a stop knowing that its EVD-related system is communicating with EVDs associated with oncoming vehicle traffic so that the vehicles may know to come to a complete stop and ensuring the safety of children.

The direction of a hazard or emergency vehicle's approach can be determined using a direction module.

An emergency vehicle detection system in its simplest form can use vehicle based emergency vehicle detectors (EVDs) to detect high pitch sounds associated with emergency vehicle sirens, such as those used on ambulances, fire engines and police vehicles. In its more developed state an emergency vehicle detection system can include a signal generator (radio frequency, radar and/or optical) that can be placed within an emergency vehicle to transmit either radar or infrared signatures into civilian vehicles containing EVDs, thereby allowing the civilian vehicles and emergency vehicles to communicate. The direction or approach of an emergency vehicle or hazard can be determined with respect to the user's location or direction of travel using a direction module associated with an EVD. With use of an emergency detection system as described herein, motorists can actively and more accurately interpolate hazards and react accordingly.

1. An emergency vehicle detector (EVD) system operating as a safety device in association with a motor vehicle and enabling motor vehicle operators to be warned of hazards and existing near the motor vehicle or within its path of travel, comprising:
an emergency signal detector adapted to detect emergency signal emitted by emergency transmitters;
a direction module for determining the general location of the emergency signal's emission with respect to the motor vehicle; and
alarm generator for generating at least one of an audible and visual alarm for motor vehicle operators.

2. The system of claim 1 wherein an emergency signal detector is adapted to detect an optical signature emitted from an emergency transmitter.

3. The system of claim 1 wherein an emergency signal detector is adapted to detect a radio frequency emitted from an emergency transmitter.

4. The system of claim 1 wherein an emergency signal detector is adapted to detect radar emitted from an emergency transmitter.

5. The system of claim 1 wherein an emergency signal detector is adapted to detect infrared signatures emitted from an emergency transmitter.

6. The system of claim 1 wherein said direction module determines the location of the emergency signal's emission with respect to the motor vehicle using GPS location information transmitted by the emergency transmitter.

7. The system of claim 1 wherein said direction module determines the location of the emergency signal's emission with respect to the motor vehicle using signal emission triangulation based on receipt of signals being transmitted by the emergency transmitters.

8. The system of claim 3 wherein said direction module determines the location of the emergency signal's emission with respect to the motor vehicle using GPS location information transmitted by the emergency transmitter.

9. The system of claim 2 wherein said direction module determines the location of the emergency signal's emission with respect to the motor vehicle using signal emission triangulation based on receipt of signals being transmitted by the emergency transmitters.

10. The system of claim 4 wherein said direction module determines the location of the emergency signal's emission with respect to the motor vehicle using signal emission triangulation based on receipt of signals being transmitted by the emergency transmitters.

11. The system of claim 5 wherein said direction module determines the location of the emergency signal's emission with respect to the motor vehicle using signal emission triangulation based on receipt of signals being transmitted by the emergency transmitters.

12. An emergency vehicle detector (EVD) system operating as a safety device in association with a motor vehicle and enabling motor vehicle operators to be warned of hazards and existing near the motor vehicle or within its path of travel, comprising:
an emergency signal detector adapted to detect emergency signal emitted by emergency transmitters;
a direction module for determining the general location of the emergency signal's emission with respect to the motor vehicle;
an alarm generator for generating a visual alarm;
a display for indicating the direction of an emergency with respect to the motor vehicle.

13. The system of claim 12 wherein said display is adapted for indicating emergency location by: illumination of “L” indicating that the emergency is located to the left of the motor vehicle; illumination of “B” indicating that the emergency is located behind the motor vehicle; illumination of “F” indicating that the emergency is located to the front of the motor vehicle; and illumination of “R” indicating that the emergency is located to the right of the motor vehicle.

14. The system of claim 13 wherein said display is adapted for indicating emergency location by illuminating “”LF”, “RF”, “LB” and “RB” indicating the emergency is located between locations “L”, “R”, “F”, and “B”.

15. A method of detecting the announcement of an emergency, comprising the steps of:
providing a vehicle-based emergency detection unit for detecting the existence of a hazard or emergency near a motor vehicle housing the emergency detection unit;
receiving an emergency signal transmitted by a emergency signal transmitter using the emergency detection unit;
determining the location of an emergency using said emergency detection unit, wherein the location is based on the signal transmitted by the emergency signal transmitter and received by the emergency detection unit;
providing an alarm, said alarm including at least one of an audio and visual indication, to occupants within the motor vehicle, said alarm indicating that a nearby emergency exists and also indicating the general location of the emergency based on said step of determining the location of an emergency carried out by the emergency detection unit.

16. The method of claim 15 wherein the step of determining the location of an emergency includes processing of GPS information by the emergency detection unit.

17. The method of claim 15 wherein the step of determining the location of an emergency includes triangulation analysis of signal emission information by the emergency detection unit.

18. The method of claim 15 wherein the emergency signal transmitter includes at least one of: ambulances, police cars, fire engines, school buses and stationary targets including crosswalks and school zones.

19. The method of claim 16 wherein the emergency signal transmitter includes at least one of: ambulances, police cars, fire engines, school buses and stationary targets including crosswalks and school zones.

20. The method of claim 17 wherein the emergency signal transmitter includes at least one of: ambulances, police cars, fire engines, school buses and stationary targets including crosswalks and school zones.
